(19) United States
(12) Patent Application Publication
(10) Pub. No.: US 2018/0112994 A1
(43) Pub. Date: Apr. 26, 2018

(54) IN-VEHICLE DEVICE, ROUTE GUIDANCE SYSTEM, COMPUTER PROGRAM PRODUCT AND METHOD THEREFOR

(71) Applicant: TOYOTA JIDOSHA KABUSHIKI KAISHA, Toyota-shi (JP)

(72) Inventors: Norihisa FUJIKAWA, Okazaki-shi (JP); Daisuke TANIZAKI, Okazaki-shi (JP); Koji OGAWA, Okazaki-shi (JP); Xin JIN, Nagoya-shi (JP)

(73) Assignee: TOYOTA JIDOSHA KABUSHIKI KAISHA, Toyota-shi (JP)

(21) Appl. No.: 15/789,436

(22) Filed: Oct. 20, 2017

(30) Foreign Application Priority Data
Oct. 21, 2016 (JP) 2016-206556

(51) Int. Cl. G01C 21/36; G01C 21/34

(52) U.S. Cl. CPC G01C 21/3655; G01C 21/3688; G01C 21/3415

(57) ABSTRACT

There is provided an in-vehicle device, which is mounted in a vehicle, that receives, from a center device, a traveling route of the vehicle searched for by the center device in response to a request from the in-vehicle device and guides regarding the received traveling route of the vehicle, the in-vehicle device including a calculation unit that calculates a response waiting time during which the in-vehicle device is able to wait from the request until the guidance regarding the traveling route of the vehicle, a determination unit that determines whether to update the traveling route of the vehicle based on the response waiting time calculated by the calculation unit and an update unit that updates the traveling route of the vehicle based on a determination result of the determination unit.

### BACKGROUND

### Technical Field

The present invention relates to an in-vehicle device, a route guidance system, a computer program product, and a method therefor.

### Related Art

Conventionally, as a technique for re-searching a traveling route of a vehicle from a departure point to a destination, there is provided a device that sets, when a traveling route is re-searched for, a section from a current position of the vehicle to a position at a predetermined distance ahead of the vehicle as a section in which the vehicle cannot turn right or left (hereinafter, referred to as a “linear priority section”), re-searches for a traveling route which does not include branch points positioned in the linear priority section while the vehicle is traveling the linear priority section, and updates the traveling route (for example, see JP 2011-2361 A). According to such a technique, it is possible to suppress the search and guidance regarding a traveling route to cause a sudden right or left turn when the route of a vehicle is changed, as compared with the case where the traveling route is re-searched for without setting a linear priority section.

### SUMMARY

### Technical Problem

However, in the above conventional technique, when, for example, a vehicle has passed a linear priority section before the end of a search because the searching process takes time, the search and guidance regarding a vehicle traveling route to cause a sudden right or left turn when the route of the vehicle is changed can be performed, and it is difficult to perform guidance regarding a safe traveling route. Therefore, there has been room for improvement from the viewpoint of a user's convenience in route searching.

The present invention has been made in view of the above, and is to provide an in-vehicle device, a route guidance system, and a computer program product which can improve a user's convenience in route searching.

### Solution to Problem

In order to solve the above problem and achieve the purpose, an in-vehicle device according to an embodiment of the present invention is an in-vehicle device, which is mounted in a vehicle, that receives, from a center device, a traveling route of the vehicle searched for by the center device in response to a request from the in-vehicle device and guides regarding the received traveling route of the vehicle, the in-vehicle device including a calculation unit for calculating a response waiting time during which the in-vehicle device is able to wait from the request until the guidance regarding the traveling route of the vehicle, a determination unit for determining whether to update the traveling route of the vehicle based on the response waiting time calculated by the calculation unit, and an update unit for updating the traveling route of the vehicle based on a determination result of the determination unit.

A route guidance system according to an embodiment of the present invention is a route guidance system that guides regarding a traveling route of a vehicle, the route guidance system including an in-vehicle device mounted in the vehicle, and a center device communicably connected to the in-vehicle device, in which the center device includes a center side communication unit for mutually communicating with the in-vehicle device, and a search unit for searching for the traveling route of the vehicle in response to a request from the in-vehicle device, the in-vehicle device includes an in-vehicle communication unit for mutually communicating with the center device, a calculation unit for calculating a response waiting time during which the in-vehicle device is able to wait from the request until reception of the traveling route of the vehicle, a determination unit for determining whether to update the traveling route of the vehicle based on the response waiting time calculated by the calculation unit, and an update unit for updating the traveling route of the vehicle based on a determination result of the determination unit, the calculation unit of the in-vehicle device calculates the response waiting time, the in-vehicle communication unit of the in-vehicle device transmits information indicating the request to the center device, the search unit of the center device searches for the traveling route of the vehicle when the center side communication unit receives the information indicating the request, the center side communication unit of the center device transmits information indicating the traveling route of the vehicle searched for by the search unit, the determination unit of the in-vehicle device determines whether to update the traveling route of the vehicle when the in-vehicle communication unit receives the information indicating the traveling route of the vehicle, and the update unit of the in-vehicle device updates the traveling route of the vehicle based on a determination result of the determination unit.

A computer program product according to an embodiment of the present invention is a computer program product for an in-vehicle device, which is mounted in a vehicle, that receives, from a center device, a traveling route of the vehicle searched for by the center device in response to a request from the in-vehicle device and guides regarding the received traveling route of the vehicle, the computer program product comprising: a non-transitory computer-readable storage medium; and a computer-readable program stored on the non-transitory computer-readable storage medium, wherein the computer-readable program is processable by the in-vehicle device for causing the device to perform operations including: calculating a response waiting time during which the in-vehicle device is able to wait from the request until the guidance regarding the traveling route of the vehicle; determining whether to update the traveling route of the vehicle based on the response waiting time calculated by the calculation unit; and updating the traveling route of the vehicle based on a determination result of the determination unit.

A method according to an embodiment of the present invention is a method for guides regarding a traveling route of a vehicle by an in-vehicle device, which is mounted in the vehicle, that receives, from a center device, the traveling route of the vehicle searched for by the center device in response to a request from the in-vehicle device, the method comprising steps of: calculating a response waiting time during which the in-vehicle device is able to wait from the request until the guidance regarding the traveling route of the vehicle; determining whether to update the traveling route of the vehicle based on the response waiting time calculated by the calculation unit; and updating the traveling route of the vehicle based on a determination result of the determination unit.

According to an in-vehicle device according to an embodiment of the present invention, since a determination unit for determining whether to update a traveling route of a vehicle based on a response waiting time calculated by a calculation unit, and an update unit for updating the traveling route of the vehicle based on a determination result of the determination unit are provided, it is possible to reliably avoid updating the traveling route of the vehicle to cause a sudden right or left turn when the route of the vehicle is changed although it takes more time to search for the traveling route of the vehicle compared to the conventional technique (that is, the technique for updating a traveling route of a vehicle by setting a linear priority section), and to improve a user's convenience in route searching.

According to a route guidance system according to an embodiment of the present invention, since a determination unit of an in-vehicle device determines whether to update a traveling route of a vehicle when an in-vehicle communication unit receives information indicating the traveling route of the vehicle, and an update unit of the in-vehicle device updates the traveling route of the vehicle based on a determination result of the determination unit, it is possible to reliably avoid updating the traveling route of the vehicle to cause a sudden right or left turn when the route of the vehicle is changed although it takes more time to search for the traveling route of the vehicle compared to the conventional technique, and to improve a user's convenience in route searching.

According to a computer program product according to an embodiment of the present invention, since an in-vehicle device is caused to perform operations including: calculating a response waiting time during which the in-vehicle device is able to wait from the request until the guidance regarding the traveling route of the vehicle; determining whether to update the traveling route of the vehicle based on the response waiting time calculated by the calculation unit; and updating the traveling route of the vehicle based on a determination result of the determination unit, it is possible to reliably avoid updating the traveling route of the vehicle to cause a sudden right or left turn when the route of the vehicle is changed although it takes more time to search for the traveling route of the vehicle compared to the conventional technique (that is, the technique for updating a traveling route of a vehicle by setting a linear priority section), and to improve a user's convenience in route searching.

According to a method according to an embodiment of the present invention, since it is determined whether to update a traveling route of a vehicle based on a response waiting time calculated by a calculation unit, and the traveling route of the vehicle is updated based on a determination result of the determination unit are provided, it is possible to reliably avoid updating the traveling route of the vehicle to cause a sudden right or left turn when the route of the vehicle is changed although it takes more time to search for the traveling route of the vehicle compared to the conventional technique (that is, the technique for updating a traveling route of a vehicle by setting a linear priority section), and to improve a user's convenience in route searching.

### BRIEF DESCRIPTION OF DRAWINGS

FIG. 1 is a block diagram showing an example of a route guidance system according to an embodiment of the present invention;

FIG. 2 is a flowchart of a route guidance process of an in-vehicle device according to the embodiment;

FIG. 3 is a flowchart of the route guidance process following FIG. 2; and

FIG. 4 is a flowchart of a route guidance process of a center device according to the embodiment.

### DETAILED DESCRIPTION

An embodiment of an in-vehicle device, a route guidance system, a computer program product, and a method therefor according to an embodiment of the present invention will be described in detail below with reference to the drawings. However, the present invention is not limited by the embodiment.

### Basic Concept of Embodiment

First, the basic concept of the embodiment will be described.

A route guidance system according to the embodiment of the present invention is a system for guiding regarding a vehicle traveling route. Here, a “vehicle traveling route” is a route from a departure place to a destination. In addition, a “departure place” is a point from which a user starts moving, and a “destination” is a point to which the user moves. Furthermore, a device functioning as the route guidance system is a device that guides regarding a vehicle traveling route, includes a plurality of devices connected by, for example, radio, and will be described as an in-vehicle device mounted in the vehicle, and a center device provided at a base station (not shown) or the like in the embodiment.

### Specific Details of Embodiment

Next, specific details of the embodiment will be described.

(Configuration)

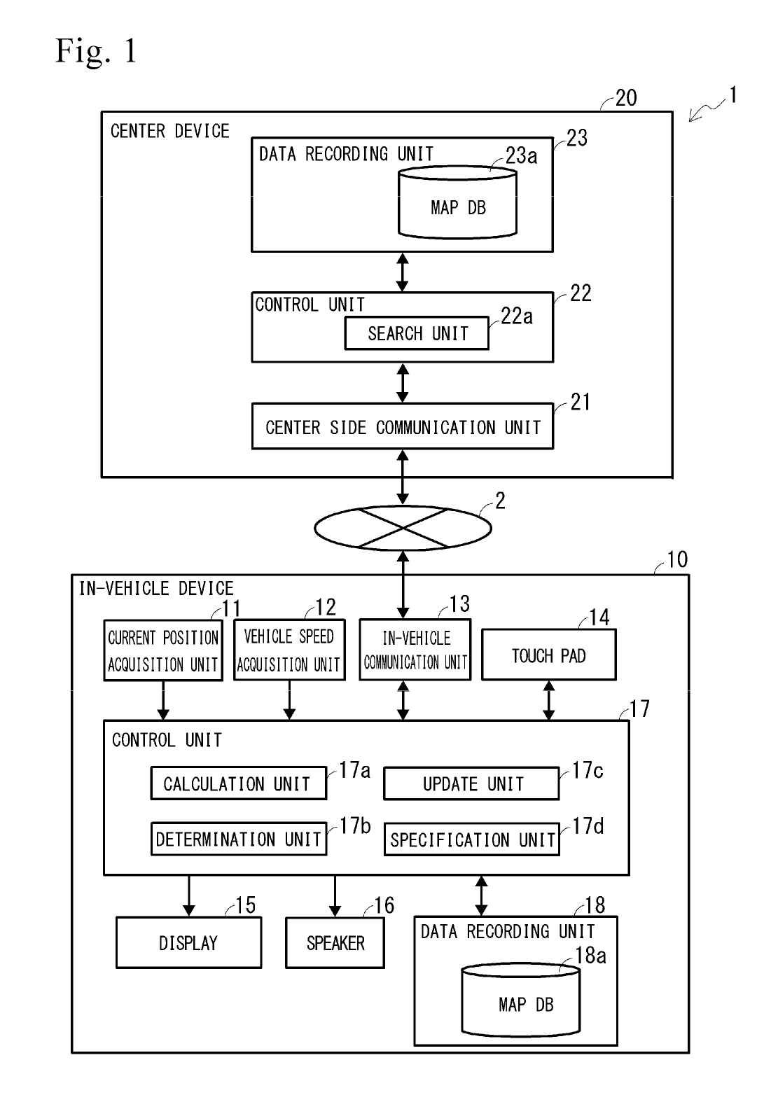

First, a configuration of a route guidance system according to the embodiment will be described. FIG. 1 is a block diagram showing an example of a route guidance system according to the embodiment of the present invention. As shown in FIG. 1, a route guidance system 1 includes an in-vehicle device 10 and a center device 20, and the in-vehicle device 10 and the center device 20 are connected via a network 2 so as to communicate with each other. FIG. 1 shows only one in-vehicle device 10, but actually the route guidance system 1 includes a plurality of in-vehicle devices 10 mounted in a plurality of vehicles, and a common center device 20 capable of communicating with the in-vehicle devices 10. However, since the in-vehicle devices 10 of the vehicles can be configured to be similar to each other, the description regarding an in-vehicle device 10 mounted in one vehicle (hereinafter, referred to as an “own vehicle”) will be made, and the description regarding an in-vehicle device 10 mounted in another vehicle other than the own vehicle will be omitted in the following description. When it is unnecessary to distinguish the own vehicle from other vehicles, they are simply referred to as “vehicles”. In addition, an “own vehicle” is a concept including a four-wheeled vehicle, a two-wheeled vehicle, a bicycle, and the like, but will be described as a four-wheeled vehicle in the embodiment.

(Configuration: In-Vehicle Device)

Next, the configuration of the in-vehicle device 10 will be described. The in-vehicle device 10 receives, from the center device 20, a vehicle traveling route searched for by the center device 20 in response to a request from the in-vehicle device 10 (hereinafter, referred to as a “request”), and guides regarding the received vehicle traveling route. As shown in FIG. 1, the in-vehicle device 10 includes a current position acquisition unit 11, a vehicle speed acquisition unit 12, an in-vehicle communication unit 13, a touch pad 14, a display 15, a speaker 16, a control unit 17, and a data recording unit 18. Since the in-vehicle device 10 can be constituted by, for example, a known in-vehicle navigation device mounted in an own vehicle, the detailed description thereof is omitted.

(Configuration: Current Position Acquisition Unit of In-Vehicle Device)

The current position acquisition unit 11 is a current position acquisition unit for acquiring the current position of the own vehicle. The current position acquisition unit 11 is constituted by, for example, a GPS receiver, and detects the current position, orientation, and the like of the own vehicle by a known method.

(Configuration: Vehicle Speed Acquisition Unit of In-Vehicle Device)

The vehicle speed acquisition unit 12 is a vehicle speed acquisition unit for acquiring the speed of the own vehicle, and outputs, for example, a vehicle speed pulse signal proportional to the rotation speed of the axle to the control unit 17. This vehicle speed sensor is constituted by, for example, a known vehicle speed sensor.

(Configuration: In-Vehicle Communication Unit of In-Vehicle Device)

The in-vehicle communication unit 13 is an in-vehicle communication unit for communicating with the center device 20 via the network 2. The specific type and configuration of this in-vehicle communication unit 13 is arbitrary. For example, a known mobile radio communication unit, a known radio communication unit for a VICS (registered trademark) system via FM multiplex broadcasting or a beacon, or the like can be used.

(Configuration: Touch Pad of In-Vehicle Device)

The touch pad 14 is an operation unit for accepting various operation inputs from a user by being pressed with the user's finger or the like. The specific configuration of the touch pad 14 is arbitrary. For example, a known one including an operation position detection unit by a resistive film method, a capacitance method, or the like can be used.

(Composition: Display of In-Vehicle Device)

The display 15 is a display unit for displaying various images under the control of the control unit 17. The specific configuration of the display 15 is arbitrary. For example, a known flat panel display such as a liquid crystal display or an organic EL display, or the like can be used. Note that, the touch pad 14 and the display 15 may be integrally formed as the touch pad 14.

(Configuration: Speaker of In-Vehicle Device)

The speaker 16 is a sound output unit for outputting various sounds under the control of the control unit 17. The specific form of the sound output from the speaker 16 is arbitrary, and a synthesized sound generated as necessary or a prerecorded sound can be output.

(Configuration: Control Unit of In-Vehicle Device)

The control unit 17 is a control unit for controlling the in-vehicle device 10, and is specifically a computer that includes a CPU, various programs (including basic control programs such an OS and application programs activated in the OS to implement specific functions) interpreted and executed on the CPU, and an internal memory such as a RAM for storing programs and various kinds of data. In particular, in-vehicle programs according to the embodiment substantially constitute the units of the control unit 17 by being installed in the in-vehicle device 10 via an arbitrary recording medium or the network 2.

As shown in FIG. 1, the control unit 17 further includes a calculation unit 17a, a determination unit 17b, an update unit 17c, and a specification unit 17d as functional concepts.

The calculation unit 17a is a calculation unit for calculating a response waiting time. Here, a “response waiting time” means a time during which the in-vehicle device 10 can wait from the above request until the guidance regarding the vehicle traveling route. The “response waiting time” is a concept including a time according to, for example, a vehicle traveling state (for example, a stopping state, a traveling state, and the like) and a traveling environment of a vehicle traveling route (for example, a type of road, a congestion situation, and the like). In the embodiment, the “response waiting time” is described based on the assumption that a first response waiting time, a second response waiting time, a third response waiting time, and a fourth response waiting time, which are to be described later, are included.

The determination unit 17b is a determination unit for determining whether to update the vehicle traveling route based on the response waiting time calculated by the calculation unit 17a.

The update unit 17c is an update unit for updating the vehicle traveling route based on the determination result by the determination unit 17b.

The specification unit 17d is a specification unit for specifying a route search processing time. Here, a “route search processing time” means a time required from the above request until the reception of the vehicle traveling route. The details of the process performed by the control unit 17 will be described later.

(Configuration: Data Recording Unit of In-Vehicle Device)

The data recording unit 18 is a recording unit for recording programs and various types of data necessary for the in-vehicle device 10 to operate, and is constituted by, for example, a hard disk (not shown) as an external recording device. However, instead of a hard disk, or together with a hard disk, arbitrary other recording mediums including a magnetic recording medium such as a magnetic disk, an optical recording medium such as a DVD or a Blu-ray disc, an electronic recording medium such as a Flash Rom, a USB memory, or an SD card can be used (this also applies to the configuration of a data recording unit 23 of the center device 20 to be described later).

The data recording unit 18 further includes a map database (hereinafter, a database is referred to as a “DB”) 18a. The map DB 18a is a map information storage unit for storing map information. In addition, “map information” is information necessary for specifying various positions including roads, road structures, and facilities, and is constituted by including, for example, node data (for example, node IDs, coordinates, and the like) on nodes installed on a road, link data (for example, link IDs, link names, connection node IDs, road coordinates, road types (for example, toll roads, ordinary roads, and the like), the number of lanes, and the like) on links set on the road, feature data (for example, traffic lights, road signs, guardrails, facilities, and the like), and topographical data (this also applies to map information stored in a map DB 23a of the center device 20 to be described later).

(Configuration: Center Device)

Next, the configuration of the center device 20 will be described. The center device 20 is a device that transmits traveling route information to be described later when request information to be described later is received. As shown in FIG. 1, the center device 20 includes a center side communication unit 21, a control unit 22, and a data recording unit 23. Since the center device 20 can be constituted by, for example, a known server installed at a base station, the detailed description thereof is omitted.

(Configuration: Center-Side Communication Unit of Center Device)

The center side communication unit 21 is a communication unit for communicating with the in-vehicle device 10 via the network 2. The specific type and configuration of the center side communication unit 21 is arbitrary. For example, a known mobile radio communication unit, a known radio communication unit for a VICS (registered trademark) system via FM multiplex broadcasting or a beacon, or the like can be used.

(Configuration: Control Unit of Center Device)

The control unit 22 is a control unit for controlling the center device 20, and includes a search unit 22a as a functional concept as shown in FIG. 1. The search unit 22a is a search unit for searching for a vehicle traveling route. The details of the process performed by the control unit 22 will be described later.

(Configuration: Data Recording Unit of Center Device)

The data recording unit 23 is a recording unit for recording programs and various types of data necessary for the center device 20 to operate, and includes a map DB 23a. The map DB 23a is a map information storage unit for storing map information.

(Route Guidance Process)

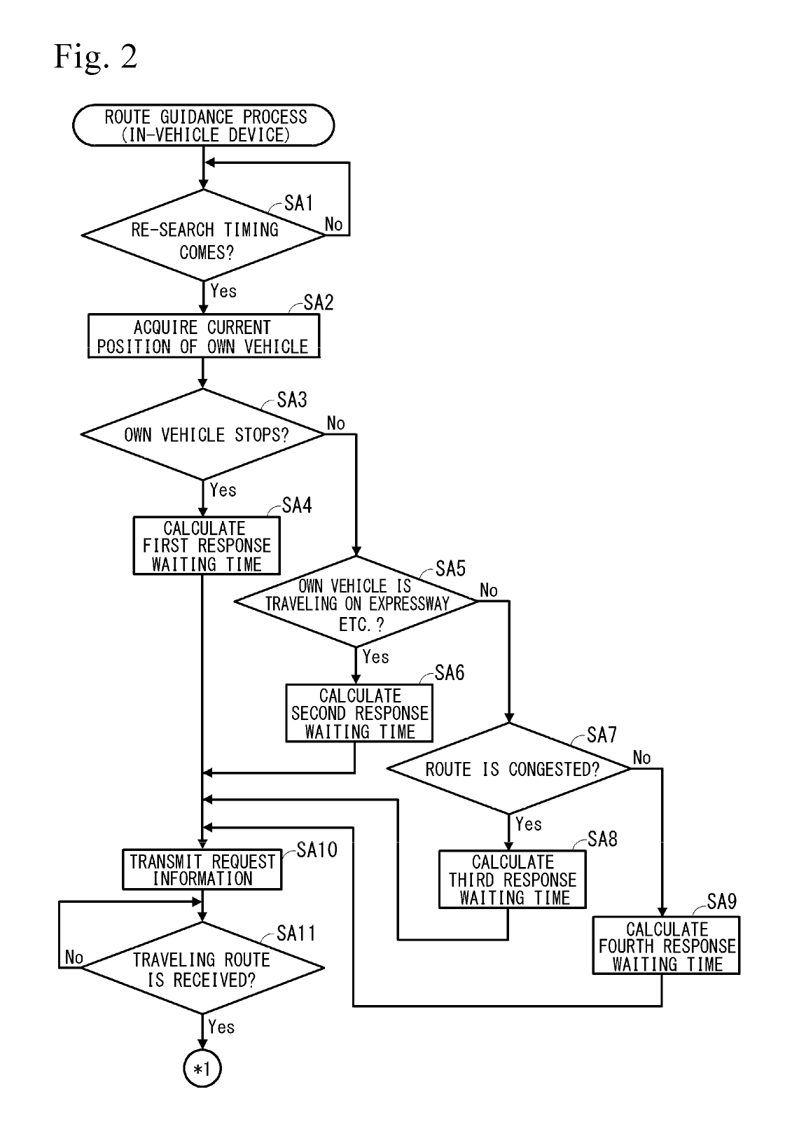

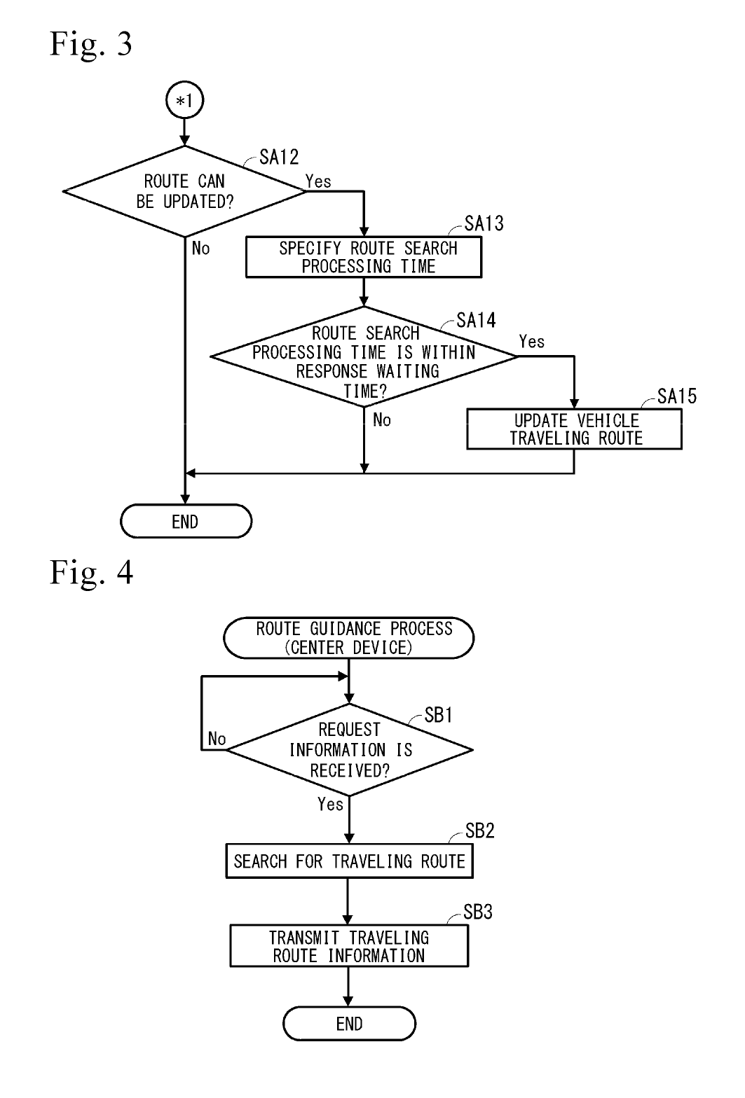

Next, a route guidance process performed by the route guidance system 1 having such a configuration will be described. FIG. 2 is a flowchart of a route guidance process of the in-vehicle device 10 according to the embodiment (the term “step” will be abbreviated as “S” in the following description of processes). FIG. 3 is a flowchart of the route guidance process following FIG. 2. FIG. 4 is a flowchart of a route guidance process of the center device 20 according to the embodiment. The route guidance process is roughly a process for guiding regarding a vehicle traveling route. The timing to perform the route guidance process is arbitrary, and it is assumed that the process is started after the in-vehicle device 10 and the center device 20 are turned on in the embodiment. The route guidance process is based on the assumption that an own vehicle is traveling on a vehicle traveling route which is a preset vehicle traveling route and displayed for guiding on the display 15 (hereinafter, referred to as a “first traveling route”).

When the route guidance process is started, as shown in FIGS. 2 and 4, in order for the in-vehicle device 10 to receive traveling route information to be described later from the center device 20, the control unit 17 of the in-vehicle device 10 performs the processes from SA1 to SA11 in FIG. 2, and the control unit 22 of the center device 20 performs the processes from SB1 to SB3 in FIG. 4 simultaneously.

First, as shown in FIG. 2, the control unit 17 of the in-vehicle device 10 determines whether a re-search timing comes in SA1. Here, a “re-search timing” means a timing at which the vehicle traveling route needs to be re-searched for. The method of determining whether the re-search timing comes is arbitrary. For example, the determination is performed based on the determination as to whether the own vehicle deviates from the first traveling route based on the current position of the own vehicle acquired by the current position acquisition unit 11 in the process in SA1 and the map information stored in the map DB 18a, as to whether the driving environment of the first traveling route is changed based on the driving environment information (for example, weather information, traffic information, and the like) acquired via the in-vehicle communication unit 13 in the process in SA1, or as to whether a periodical timing (for example, a timing of 5 minute interval or the like) comes. Here, when the own vehicle deviates from the first traveling route, when the driving environment of the first traveling route is changed, or when the periodic timing comes, it is determined that the re-search timing comes. On the other hand, when the own vehicle does not deviate from the first traveling route, when the driving environment of the first traveling route is not changed, or when the periodic timing does not come, it is determined that the re-search timing does not come. Then, the control unit 17 of the in-vehicle device 10 waits until the re-search timing comes (SA1: No), and when it is determined that the re-search timing comes (SA1: Yes), the control unit 17 proceeds the process to SA2.

In SA2, the control unit 17 of the in-vehicle device 10 acquires the current position of the own vehicle via the current position acquisition unit 11.

In SA3, the control unit 17 of the in-vehicle device 10 determines whether the own vehicle stops. Here, the term “stop” means that a vehicle stops for a predetermined time (that is, the vehicle speed is 0 km/h) regardless of the on/off state of the engine of the vehicle. In addition, the “predetermined time” is set to the time for guiding with a margin if it takes time to re-search for the vehicle traveling route, and is set to, for example, 5 to 30 seconds in the embodiment. However, the predetermined time is not limited thereto, and may be set to a relatively long time (for example 5 minutes) if it is expected that the re-searching time is too long. The method of determining whether the own vehicle stops is arbitrary. For example, the determination is performed based on the determination as to whether a plurality of vehicle speeds acquired by the vehicle speed acquisition unit 12 from the start of process in SA3 until the predetermined time passes includes the vehicle speed of 0 km/h. Here, when the vehicle speed of 0 km/h is included, it is determined that the own vehicle stops. On the other hand, when the vehicle speed of 0 km/h is not included, it is determined that the own vehicle does not stop. When it is determined that the own vehicle stops (SA3: Yes), the control unit 17 of the in-vehicle device 10 proceeds the process to SA4, or when it is determined that the vehicle does not stop (SA3: No), the control unit 17 proceeds the process to SA5.

In SA4, the calculation unit 17a of the in-vehicle device 10 calculates a first response waiting time. Here, a “first response waiting time” is a response waiting time corresponding to the determination that the own vehicle stops in SA3. The method of calculating the first response waiting time is arbitrary. For example, a time recorded in the data recording unit 18 in advance and set to be longer than the other response waiting times (for example, 100 minutes or the like) is calculated as the first response waiting time. Thereafter, the control unit 17 of the in-vehicle device 10 proceeds the process to SA10.

In SA5, the control unit 17 of the in-vehicle device 10 determines whether the own vehicle is traveling on an expressway or a toll road. The method of determining whether the own vehicle is traveling on an expressway or a toll road is arbitrary. For example, the determination is performed based on the determination as to whether the type of the link matching the current position of the own vehicle acquired in SA2 is an expressway or a toll road based on the map information (especially, link data) stored in the map DB 18a. Here, when the type of the link is an expressway or a toll road, it is determined that the own vehicle is traveling on an expressway or a toll road. On the other hand, when the type of the link is not an expressway or a toll road, it is determined that the own vehicle is not traveling on an expressway or a toll road. Then, when it is determined that the own vehicle is traveling on an expressway or a toll road (SA5: Yes), the control unit 17 of the in-vehicle device 10 proceeds the process to SA6, or when it is determined that the own vehicle is not traveling on an expressway or a toll road (SA5: No), the control unit 17 proceeds the process to SA7.

In SA6, the calculation unit 17a of the in-vehicle device 10 calculates a second response waiting time. Here, a “second response waiting time” is a response waiting time corresponding to the determination that the own vehicle is traveling on an expressway or a toll road in SA5. The method of calculating the second response waiting time is arbitrary. In the embodiment, a value obtained by calculating the distance from the current position of the own vehicle acquired in SA2 to a next guidance point based on the first traveling route and the map information stored in the map DB 18a, and dividing the calculated distance by a predetermined vehicle speed stored in the data recording unit 18 in advance and corresponding to the type of the road on which the own vehicle is currently traveling (or the speed of the own vehicle acquired by the vehicle speed acquisition unit 12 simultaneously with the process in SA2), that is, the time required for the own vehicle to reach the next guidance point from the current position of the own vehicle is calculated as the second response waiting time. Here, a “next guidance point” means a point at which the guidance regarding the vehicle traveling route is performed next from the current position of the own vehicle at the time of the request acquired in SA2. The “next guidance point” is a concept including, for example, a physical branch point (for example, an interchange of an expressway, an intersection of an ordinary road, or the like), and a point earlier than a physical branch point and at which the guidance regarding the traveling route is notified (hereinafter, referred to as a “guidance notifying point”). Note that, the “next guide point” in the case of calculating the second response waiting time is, for example, an interchange at which the own vehicle is scheduled to get off, a guidance notifying spot earlier than the interchange at which the own vehicle is scheduled to get off, or the like among the interchanges of the expressway on which the own vehicle is traveling. Thereafter, the control unit 17 of the in-vehicle device 10 proceeds the process to SA10.

In SA7, the control unit 17 of the in-vehicle device 10 determines whether the first traveling route (specifically, the section ahead of the own vehicle in the section of the first traveling route) is congested. The method of determining whether the first traveling route is congested is arbitrary. For example, the determination is performed based on the determination as to whether the congestion length of the first traveling route, which is specified based on the map information (especially, link data) stored in the map DB 18a and the traffic information (congestion information) acquired via the in-vehicle communication unit 13, is equal to or greater than a threshold value (for example, 3 km or more) stored in the data recording unit 18 in advance. Here, when the congestion length is equal to or greater than the threshold value, it is determined that the first traveling route is congested. On the other hand, when the congestion length is less than the threshold value, it is determined that the first traveling route is not congested. Then, when it is determined that the first traveling route is congested (SA7: Yes), the control unit 17 of the in-vehicle device 10 proceeds the process to SA8, or when it is determined that the first traveling route is not congested (SA7: No), the control unit 17 proceeds the process to SA9.

In SA8, the calculation unit 17a of the in-vehicle device 10 calculates a third response waiting time. Here, a “third response waiting time” is a response waiting time corresponding to the determination that the first traveling route is congested in SA7. The method of calculating the third response waiting time is arbitrary. For example, a time obtained by calculating the distance from the current position of the own vehicle acquired in SA2 to a next guidance point based on the first traveling route and the map information stored in the map DB 18a, dividing the calculated distance by the predetermined vehicle speed, and adding an additional time to the divided value, that is, the time required for the own vehicle to reach the next guidance point from the current position of the own vehicle is calculated as the third response waiting time. Here, an “additional time” is a time stored in the data recording unit 18 and corresponding to a delay time due to congestion, and is a concept including, for example, the additional time corresponding to the congestion length specified in SA7 (for example, 30 minutes when the congestion length is 5 km). The “next guidance point” in the case of calculating the third response waiting time is, for example, an intersection closest to the current position of the own vehicle acquired in SA2, a guidance notifying spot earlier than the intersection, or the like among the intersections of the ordinary road on which the own vehicle is traveling. Thereafter, the control unit 17 of the in-vehicle device 10 proceeds the process to SA10.

In SA9, the calculation unit 17a of the in-vehicle device 10 calculates a fourth response waiting time. Here, a “fourth response waiting time” is a response waiting time corresponding to the determination that the first traveling route is not congested in SA7. The method of calculating the fourth response waiting time is arbitrary. For example, a value obtained by calculating the distance from the current position of the own vehicle acquired in SA2 to a next guidance point based on the first traveling route and the map information stored in the map DB 18a, and dividing the calculated distance by the predetermined vehicle speed, that is, the time required for the own vehicle to reach the next guidance point from the current position of the own vehicle is calculated as the fourth response waiting time. The “next guidance point” in the case of calculating the fourth response waiting time is, for example, an intersection closest to the current position of the own vehicle acquired in SA2, a guidance notifying spot earlier than the intersection, or the like among the intersections of the ordinary road (which is not congested) on which the own vehicle is traveling. Thereafter, the control unit 17 of the in-vehicle device 10 proceeds the process to SA10.

In SA10, the control unit 17 of the in-vehicle device 10 transmits request information to the center device 20. Here, “request information” is information indicating the above request. The transmission content of the request information is arbitrary. In the first embodiment, the request information including the first traveling route and the current position of the own vehicle acquired in SA2 is transmitted.

Next, as shown in FIG. 4, in SB1, the control unit 22 of the center device 20 determines whether the request information transmitted in SA10 has been received. Then, the control unit 22 of the center device 20 waits until receiving the request information (SB1: No), and when receiving the request information (SB1: Yes), the control unit 22 proceeds the process to SB2.

In SB2, based on the first traveling route, the current position of the own vehicle acquired in SA2, and the map information stored in the map DB 23a among the request information received in SB1, the search unit 22a of the center device 20 searches for a vehicle traveling route (hereinafter referred to as a “second traveling route”) using a known route searching method.

In SB3, the control unit 22 of the center device 20 transmits traveling route information to the in-vehicle device 10. Here, “traveling route information” is information indicating the second traveling route searched for in SB2. With this process, the control unit 22 of the center device 20 ends the route guidance process.

Returning to FIG. 2, in SA11, the control unit 17 of the in-vehicle device 10 determines whether the traveling route information transmitted in SB3 has been received. Then, the control unit 17 of the in-vehicle device 10 waits until receiving the traveling route information (SA11: No), and when receiving traveling route information (SA11: Yes), the control unit 17 proceeds the process to SA12.

Next, as shown in FIG. 3, in order to update the vehicle traveling route, the control unit 17 of the in-vehicle device 10 performs the processes from SA12 to SA15.

First, as shown in FIG. 3, in SA12, the determination unit 17b of the in-vehicle device 10 determines whether the vehicle traveling route can be updated using a known determination method. The method of determining whether the vehicle traveling route can be updated is arbitrary. For example, the determination is performed based on the determination as to whether the current position of the own vehicle acquired again is positioned on the second traveling route included in the traveling route information based on the traveling route information received in SA11 and the map information stored in the map DB 18a. Here, when it is determined that the own vehicle is positioned on the second traveling route, it is determined that the vehicle traveling route can be updated. On the other hand, when it is determined that the own vehicle is not positioned on the second traveling route (for example, when the own vehicle deviates from the second traveling route, or the like), it is determined that the vehicle traveling route cannot be updated. Then, when it is determined that the vehicle traveling route can be updated (SA12: Yes), the control unit 17 of the in-vehicle device 10 proceeds the process to SA13, or when it is determined that the vehicle traveling route cannot be updated (SA12: No), the control unit 17 ends the route guidance process.

In SA13, the specification unit 17d of the in-vehicle device 10 specifies the route search processing time. Specifically, the specification unit 17d of the in-vehicle device 10 calculates the time from the transmission of the request information in SA10 to the reception of the vehicle traveling route information in the SA12, and specifies the calculated time as the route search processing time.

In SA14, the determination unit 17b of the in-vehicle device 10 determines, based on the response waiting time (any one of the first response waiting time to the fourth response waiting time) calculated in SA4, SA6, SA8, or SA9, and the route search processing time specified in SA13, whether the route search processing time is within the response waiting time. Here, the reason for performing the above determination is as follows. That is, if the vehicle traveling route is updated in the case where the route search processing time exceeds the response waiting time, the vehicle traveling route can be updated to make a sudden right or left turn when the route of the own vehicle is changed. Thus, in order to avoid such a problem, the above determination is performed. Then, when it is determined that the route search processing time is within the response waiting time (SA14: Yes), the control unit 17 of the in-vehicle device 10 proceeds the process to SA15, or when it is determined that the route search processing time is not within the response waiting time (SA14: No), the control unit 17 ends the route guidance process.

In SA15, the update unit 17c of the in-vehicle device 10 updates the vehicle traveling route based on the traveling route information received in SA11. The method of updating the vehicle traveling route is arbitrary. For example, if the first traveling route is displayed so as to overlap with the map displayed on the display 15 until immediately before the process in SA14, updating is performed, that is, display guidance regarding the second traveling route is performed by displaying the second traveling route included in the traveling route information instead of the first traveling route so as to overlap with the map. Alternatively, updating may be performed by, in addition to the display of the second traveling route, outputting, from the speaker 16, sound information indicating that the vehicle traveling route has been updated. With the process, the control unit 17 of the in-vehicle device 10 ends the route guidance process.

With the above processes, since the vehicle traveling route can be updated based on the determination results in SA12 and SA14, it is possible reliably avoid updating the vehicle traveling route to cause a sudden right or left turn when the route of the own vehicle is changed.

Furthermore, with such a route guidance process, it is possible reliably avoid updating the vehicle traveling route to cause a sudden right or left turn when the vehicle route is changed although it takes more time to search for the vehicle traveling route compared to the conventional technique (that is, the technique for updating a vehicle traveling route by setting a linear priority section). In addition, unlike the conventional technique, since the linear priority section is not set when the vehicle traveling route is updated, it is possible to update the vehicle traveling route to be optimal while safety is maintained. From the above reasons, it is possible to improve a user's convenience in route searching. In particular, since any one of the first response waiting time to the fourth response waiting time is calculated, it is possible to calculate the response waiting time according to a traveling state of the vehicle and a traveling environment of the vehicle traveling route. Thus, as compared with the case where the response waiting time is a fixed time, it is possible to update the vehicle traveling route to be more optimal while safety is maintained.

### Modifications of Embodiment

The embodiment of the present invention has been described above, specific configurations and means of the present invention can be arbitrarily modified and improved within the scope of the technical idea of the present invention described in claims. Such modifications will be described below.

(Technical Problem to be Solved and Advantageous Effects of Invention)

The technical problem to be solved by the invention and the advantageous effects of the invention are not limited to the above description, can differ depending on the implementation environment and the details of the configuration of the invention. Thus, a part of the above problem can be solved, or a part of the above effects can be obtained. For example, although the convenience in route searching by the route guidance system 1 according to the embodiment of the present invention is about the same level as the conventional technique, the problem of the present invention is solved as long as the route guidance system 1 has a different configuration from the conventional technique and convenience as the same level as the conventional technique.

(Dispersion or Integration)

The above electrical components are functional conception and do not need to be physically configured as shown in the drawings. That is, the specific forms of dispersion or integration of the units are not limited to those shown in the drawing, and all or a part of them may be dispersed or integrated functionally or physically in arbitrary units according to various loads or usage situations. The term “device” in the present application is not limited to a device constituted by a single device, and includes a device constituted by a plurality of devices. For example, the in-vehicle device 10 may be configured to be dispersed to a plurality of devices configured to communicate with each other, the calculation unit 17a and the determination unit 17b may be provided in a part of the devices, and the update unit 17c and the specification unit 17d may be provided in a part of the other devices.

(Shapes, Numerical Values, Structures, and Time Series)

Regarding the constituent elements exemplified in the embodiment and the drawings, it is possible to arbitrarily modify and improve the shapes, the numerical values, or the mutual relation between the configurations between the constituent elements or between the time series within the technical idea of the present invention.

(In-Vehicle Device)

In the above embodiment, it has been described that the in-vehicle device 10 is configured using an in-vehicle navigation device. However, the in-vehicle device 10 is not limited thereto and may be constituted by, for example, a known mobile terminal such as a smartphone or a portable navigation device.

(Route Guidance Process)

In the above embodiment, it has been described that the processes in SA3, SA5, SA6, SA7, SA8, and SA12 are performed. However, the processes are not limited thereto, and at least any one of the processes in SA3, SA5, SA6, SA7, SA8, or SA12 may be omitted, for example.

Furthermore, in the above embodiment, it has been described that the process in SA10 is performed after the process in SA4, SA6, SA8, or SA9. However, the processing order of the process in SA10 is not limited thereto, and the process in SA10 may be performed, for example, before the process in SA4, SA6, SA8, or SA9, or may be performed at the same time as the process in SA4, SA6, SA8, or SA9.

In the above embodiment, it has been described that the time required for the own vehicle to reach the next guidance point from the current position of the own vehicle in SA6 is calculated as the second response waiting time, but the second response waiting time is not limited thereto. For example, when an expressway road or a toll road on which the own vehicle is traveling is congested, the time obtained by adding the additional time to the time required for the own vehicle to reach the next guidance point from the current position of the own vehicle may be calculated as the second response waiting time.

Furthermore, in the above embodiment, it has been described that the processes from SA10 to SA15 are performed regardless of the length of the response waiting time calculated in SA4, SA6, SA8, or SA9, but the process is not limited thereto. For example, when the response waiting time calculated in SA4, SA6, SA8, or SA9 is a very short time, the route guidance process may be ended.

(Response Waiting Time)

In the above embodiment, it has been described that, in the route guidance process, the second response waiting time to the fourth response waiting time are calculated as the time required for the own vehicle to reach the next guidance point from the current position of the own vehicle (or the time obtained by adding the additional time to the required time), but are not limited thereto. For example, the second response waiting time to the fourth response waiting time may be calculated by subtracting a margin time from the time required for the own vehicle to reach the next guidance point from the current position of the own vehicle (or the time obtained by adding the additional time to the required time). Here, a “margin time” is a time for the response waiting time to have a margin to be on the safe side in order to adjust the difference between the response waiting time and the route search processing time. The “margin time” is, for example, the time for adjusting the difference between the end point of each of the second response waiting time to the fourth response waiting time (that is, until the guidance regarding the vehicle traveling route) and the end point of the route search processing time (that is, until the reception of the vehicle traveling route), or the time for adjusting an excess time in the case where it is expected that the processing time from the processes in SA12 to SA15 exceeds the predetermined time. Accordingly, it is possible to calculate the second response waiting time to the fourth response waiting time taking the difference between the end point of each of the second response waiting time and the fourth response waiting time and the end point of the route search processing time into consideration. When it is expected that the processing time from the processes in SA12 to SA15 exceeds the predetermined time, it is possible to calculate the second response waiting time to the fourth response waiting time taking the excess time into consideration. From the above reasons, it is possible to calculate the more optimal second response waiting time to fourth response waiting time.

### Part of Features and Effects of Embodiment

Finally, a part of the features and effects of the embodiment described above are exemplified below. However, the features and effects of the embodiment are not limited to the following description, and a part of the following features can be obtained by achieving a part of the following effects, or effects other than the following effects can be obtained by achieving features other than the following features.

An in-vehicle device according to an aspect 1 in an embodiment is an in-vehicle device, which is mounted in a vehicle, that receives, from a center device, a traveling route of the vehicle searched for by the center device in response to a request from the in-vehicle device and guides regarding the received traveling route of the vehicle, the in-vehicle device including a calculation unit for calculating a response waiting time during which the in-vehicle device is able to wait from the request until the guidance regarding the traveling route of the vehicle, a determination unit for determining whether to update the traveling route of the vehicle based on the response waiting time calculated by the calculation unit, and an update unit for updating the traveling route of the vehicle based on a determination result of the determination unit.

According to the in-vehicle device in the aspect 1, since a determination unit for determining whether to update a traveling route of a vehicle based on a response waiting time calculated by a calculation unit, and an update unit for updating the traveling route of the vehicle based on a determination result of the determination unit are provided, it is possible to avoid updating the traveling route of the vehicle to cause a sudden right or left turn when the route of the vehicle is changed although it takes more time to search for the traveling route of the vehicle compared to the conventional technique (that is, the technique for updating a traveling route of a vehicle by setting a linear priority section), and to improve a user's convenience in route searching.

The in-vehicle device in another aspect 2 in the embodiment further includes a current position acquisition unit for acquiring a current position of the vehicle, in which the calculation unit calculates, as the response waiting time, a time required for the vehicle to reach a next guidance point, at which the guidance regarding the traveling route of the vehicle is performed next, from the current position of the vehicle at the request acquired by the current position acquisition unit.

According to the in-vehicle device in the aspect 2, in the in-vehicle device in the aspect 1, since the calculation unit calculates, as the response waiting time, a time required for the vehicle to reach a next guidance point, at which the guidance regarding the traveling route of the vehicle is performed next, from the current position of the vehicle at the request acquired by the current position acquisition unit, it is possible to calculate the response waiting time according to a traveling state of the vehicle and a traveling environment of the vehicle traveling route. Thus, as compared with the case where the response waiting time is a fixed time, it is possible to update the vehicle traveling route to be more optimal while safety is maintained.

The in-vehicle device according to another aspect 3 in the embodiment further includes a specification unit for specifying a route search processing time which is a time required from the request to the reception of the traveling route of the vehicle, in which the determination unit determines whether to update the traveling route of the vehicle based on the response waiting time calculated by the calculation unit and the route search processing time specified by the specification unit.

According to the in-vehicle device in the aspect 3, in the in-vehicle device according to the aspect 1 or 2, since the determination unit determines whether to update the traveling route of the vehicle based on the response waiting time calculated by the calculation unit and the route search processing time specified by the specification unit, it is possible to reliably avoid updating the traveling route of the vehicle to cause a sudden right or left turn when the route of the vehicle is changed, and to further improve a user's convenience in route searching.

A route guidance system in another aspect 4 in the embodiment is a route guidance system that guides regarding a traveling route of a vehicle, the route guidance system including an in-vehicle device mounted in the vehicle, and a center device communicably connected to the in-vehicle device, in which the center device includes a center side communication unit for mutually communicating with the in-vehicle device, and a search unit for searching for the traveling route of the vehicle in response to a request from the in-vehicle device, the in-vehicle device includes an in-vehicle communication unit for mutually communicating with the center device, a calculation unit for calculating a response waiting time during which the in-vehicle device is able to wait from the request until reception of the traveling route of the vehicle, a determination unit for determining whether to update the traveling route of the vehicle based on the response waiting time calculated by the calculation unit, and an update unit for updating the traveling route of the vehicle based on a determination result of the determination unit, the calculation unit of the in-vehicle device calculates the response waiting time, the in-vehicle communication unit of the in-vehicle device transmits information indicating the request to the center device, the search unit of the center device searches for the traveling route of the vehicle when the center side communication unit receives the information indicating the request, the center side communication unit of the center device transmits information indicating the traveling route of the vehicle searched for by the search unit, the determination unit of the in-vehicle device determines whether to update the traveling route of the vehicle when the in-vehicle communication unit receives the information indicating the traveling route of the vehicle, and the update unit of the in-vehicle device updates the traveling route of the vehicle based on a determination result of the determination unit.

According to the route guidance system in the aspect 4, since a determination unit of an in-vehicle device determines whether to update a traveling route of a vehicle when an in-vehicle communication unit receives information indicating the traveling route of the vehicle, and an update unit of the in-vehicle device updates the traveling route of the vehicle based on a determination result of the determination unit, it is possible to reliably avoid updating the traveling route of the vehicle to cause a sudden right or left turn when the route of the vehicle is changed although it takes more time to search for the traveling route of the vehicle compared to the conventional technique, and to improve a user's convenience in route searching.

The computer program product in another aspect 5 in the embodiment is a computer program product for an in-vehicle device, which is mounted in a vehicle, that receives, from a center device, a traveling route of the vehicle searched for by the center device in response to a request from the in-vehicle device and guides regarding the received traveling route of the vehicle, the computer program product comprising: a non-transitory computer-readable storage medium; and a computer-readable program stored on the non-transitory computer-readable storage medium, wherein the computer-readable program is processable by the in-vehicle device for causing the device to perform operations including: calculating a response waiting time during which the in-vehicle device is able to wait from the request until the guidance regarding the traveling route of the vehicle; determining whether to update the traveling route of the vehicle based on the response waiting time calculated by the calculation unit; and updating the traveling route of the vehicle based on a determination result of the determination unit.

According to the computer program product in the aspect 5, since the computer-readable program is processable by the in-vehicle device for causing the device to perform operations including: calculating a response waiting time during which the in-vehicle device is able to wait from the request until the guidance regarding the traveling route of the vehicle; determining whether to update the traveling route of the vehicle based on the response waiting time calculated by the calculation unit; and updating the traveling route of the vehicle based on a determination result of the determination unit, it is possible to reliably avoid updating the traveling route of the vehicle to cause a sudden right or left turn when the route of the vehicle is changed although it takes more time to search for the traveling route of the vehicle compared to the conventional technique (that is, the technique for updating a traveling route of a vehicle by setting a linear priority section), and to improve a user's convenience in route searching.

The method in another aspect 6 in the embodiment is a method for guides regarding a traveling route of a vehicle by an in-vehicle device, which is mounted in the vehicle, that receives, from a center device, the traveling route of the vehicle searched for by the center device in response to a request from the in-vehicle device, the method comprising steps of: calculating a response waiting time during which the in-vehicle device is able to wait from the request until the guidance regarding the traveling route of the vehicle; determining whether to update the traveling route of the vehicle based on the response waiting time calculated by the calculation unit; and updating the traveling route of the vehicle based on a determination result of the determination unit.

According to the method in another aspect 6, since it is determined whether to update a traveling route of a vehicle based on a response waiting time calculated by a calculation unit, and the traveling route of the vehicle is updated based on a determination result of the determination unit are provided, it is possible to reliably avoid updating the traveling route of the vehicle to cause a sudden right or left turn when the route of the vehicle is changed although it takes more time to search for the traveling route of the vehicle compared to the conventional technique (that is, the technique for updating a traveling route of a vehicle by setting a linear priority section), and to improve a user's convenience in route searching.

What is claimed is:

1. An in-vehicle device, which is mounted in a vehicle, that receives, from a center device, a traveling route of the vehicle searched for by the center device in response to a request from the in-vehicle device and guides regarding the received traveling route of the vehicle, the in-vehicle device comprising:
a calculation unit for calculating a response waiting time during which the in-vehicle device is able to wait from the request until the guidance regarding the traveling route of the vehicle;
a determination unit for determining whether to update the traveling route of the vehicle based on the response waiting time calculated by the calculation unit; and
an update unit for updating the traveling route of the vehicle based on a determination result of the determination unit.

2. The in-vehicle device according to claim 1, further comprising:
a current position acquisition unit for acquiring a current position of the vehicle, wherein
the calculation unit calculates, as the response waiting time, a time required for the vehicle to reach a next guidance point, at which the guidance regarding the traveling route of the vehicle is performed next, from the current position of the vehicle at the request acquired by the current position acquisition unit.

3. The in-vehicle device according to claim 1, further comprising:
a specification unit for specifying a route search processing time which is a time required from the request to the reception of the traveling route of the vehicle, wherein
the determination unit determines whether to update the traveling route of the vehicle based on the response waiting time calculated by the calculation unit and the route search processing time specified by the specification unit.

4. A route guidance system that guides regarding a traveling route of a vehicle, the route guidance system comprising:
an in-vehicle device mounted in the vehicle; and
a center device communicably connected to the in-vehicle device, wherein
the center device comprises:
a center side communication unit for mutually communicating with the in-vehicle device; and
a search unit for searching for the traveling route of the vehicle in response to a request from the in-vehicle device,
the in-vehicle device comprises:
an in-vehicle communication unit for mutually communicating with the center device;
a calculation unit for calculating a response waiting time during which the in-vehicle device is able to wait from the request until reception of the traveling route of the vehicle;
a determination unit for determining whether to update the traveling route of the vehicle based on the response waiting time calculated by the calculation unit; and
an update unit for updating the traveling route of the vehicle based on a determination result of the determination unit,
the calculation unit of the in-vehicle device calculates the response waiting time,
the in-vehicle communication unit of the in-vehicle device transmits information indicating the request to the center device,
the search unit of the center device searches for the traveling route of the vehicle when the center side communication unit receives the information indicating the request,
the center side communication unit of the center device transmits information indicating the traveling route of the vehicle searched for by the search unit,
the determination unit of the in-vehicle device determines whether to update the traveling route of the vehicle when the in-vehicle communication unit receives the information indicating the traveling route of the vehicle, and
the update unit of the in-vehicle device updates the traveling route of the vehicle based on a determination result of the determination unit.

5. A computer program product for an in-vehicle device, which is mounted in a vehicle, that receives, from a center device, a traveling route of the vehicle searched for by the center device in response to a request from the in-vehicle device and guides regarding the received traveling route of the vehicle,
the computer program product comprising:
a non-transitory computer-readable storage medium; and
a computer-readable program stored on the non-transitory computer-readable storage medium, wherein the computer-readable program is processable by the in-vehicle device for causing the device to perform operations including:
calculating a response waiting time during which the in-vehicle device is able to wait from the request until the guidance regarding the traveling route of the vehicle;
determining whether to update the traveling route of the vehicle based on the response waiting time calculated by the calculation unit; and
updating the traveling route of the vehicle based on a determination result of the determination unit.

6. A method for guides regarding a traveling route of a vehicle by an in-vehicle device, which is mounted in the vehicle, that receives, from a center device, the traveling route of the vehicle searched for by the center device in response to a request from the in-vehicle device, the method comprising steps of:
calculating a response waiting time during which the in-vehicle device is able to wait from the request until the guidance regarding the traveling route of the vehicle;
determining whether to update the traveling route of the vehicle based on the response waiting time calculated by the calculation unit; and
updating the traveling route of the vehicle based on a determination result of the determination unit.

7. The in-vehicle device according to claim 2, further comprising:
a specification unit for specifying a route search processing time which is a time required from the request to the reception of the traveling route of the vehicle, wherein
the determination unit determines whether to update the traveling route of the vehicle based on the response waiting time calculated by the calculation unit and the route search processing time specified by the specification unit.
